(19) United States
(12) Patent Application Publication
(10) Pub. No.: US 2006/0174268 A1
(43) Pub. Date: Aug. 3, 2006

(54) Media device and enhancing use of media device

(76) Inventor: Jyrki Matero, Oulu (FI)

Correspondence Address: Hollingsworth & Funk, LLC, Suite 125, 8009 34th Avenue South, Minneapolis, MN, 55425, US

(21) Appl. No.: 10/994,885

(22) Filed: Nov. 22, 2004

(51) Int. Cl. H04N 5/445; G06F 13/00; H04N 7/16; G06F 3/00

(52) U.S. Cl. 725/39; 725/62; 725/40

(57) ABSTRACT

A media device, a network server and a method of enhancing the use of a media device are provided. The media device is configured to receive a broadcast media stream transmitted by a broadcast system. Program guide information on at least one broadcast media stream is received over a radio interface of a cellular telecommunication system. The received program guide information is stored and formatted for display. At least part of the received information is displayed to the user.

### FIELD

The invention relates to a media device and enhancing the use of a media device. Especially the invention relates to media devices configured to receive a broadcast media stream from a broadcast system.

### BACKGROUND

Broadcasters, such as television and radio broadcasters, have taken steps forward to provide an audience with digital supplementary services, such as program information, news, weather information, competitions and other related content, in addition to a traditional media stream. The digital supplementary services are usually delivered to the audience over the Internet using the audiences' personal computers or other media devices capable of connecting to the Internet.

More mobility is provided for the audience by media devices of cellular telecommunication systems, which media devices are equipped with a receiver, such as an FM radio, for receiving media streams broadcast by broadcasters. Broadcasters typically provide Internet services, which can be accessed by media devices, such as one equipped with a WAP (Wireless Application Protocol), capable of connecting to such a service.

Especially in urban areas the number of available broadcast media streams may be large. Mobile users receiving media streams usually do not have prior knowledge of the content of the media streams. Program guide information may be available in digital supplementary service associated with each media stream. However, the user may monitor program guide information only regarding the media stream currently received. The user has no option to monitor other media streams. Thus, interesting programs or music are easily missed.

### BRIEF DESCRIPTION OF THE INVENTION

An object of the invention is to enhance the use of a media device by providing an improved solution for monitoring program content of different broadcast media streams. According to an aspect of the invention, there is provided a method of enhancing the use of a media device, configured to receive a broadcast media stream transmitted by a broadcast system; the method comprising: receiving over a radio interface of a cellular telecommunication system program guide information on at least one broadcast media stream; storing and formatting the received program guide information for display; displaying at least part of the received information to the user.

According to an aspect of the invention, there is provided a method of enhancing the use of a media device, configured to receive a broadcast media stream transmitted by a broadcast system; the method comprising: requesting program guide information on at least one broadcast media stream by the media device over a radio interface of a cellular telecommunication system; receiving program guide information over a radio interface of a cellular telecommunication system; storing and formatting the received program guide information for displaying; displaying at least part of the received information to the user.

According to another aspect of the invention, there is provided a media device comprising: a receiver for receiving a broadcast media stream transmitted by a broadcast system; a transceiver for communicating with a cellular telecommunication system and receiving a service transmitted over a radio interface of the cellular telecommunication system, the service being associated with at least one broadcast media stream, and for receiving program guide information relating to at least one broadcast media stream; a memory for storing the received program guide information; a processor connected to the transceiver and receiver for formatting the received information; and a user interface connected to the processor for displaying at least part of the received information to the user.

According to yet another aspect of the invention, there is provided a network server having a capability to connect to a telecommunication system and to a broadcast system transmitting a broadcast media stream, configured to receive program guide information relating to at least one broadcast media stream from the broadcast system, and send the program guide information over the radio interface of the telecommunication system to the media device having requested the information.

The invention provides several advantages. In an embodiment, program guide information on one or more media streams is shown on the display of the media device of the user simultaneously. Thus, the invention provides the user an easy way to monitor program guide information of several broadcast media streams at a glance without the need to receive the streams.

In an embodiment of the invention, the media device requests program guide information from network. The network sends the program guide information in response to the request. In another embodiment, the network sends program guide information to media devices without specific requests from the media devices. The media devices may receive the information or disregard it if the user is not interested in the service.

In an embodiment of the invention, media device may be configured to search program guide information for program items according to given search parameters and display the search results to the user. The user may give program item selection commands and the media device may be configured to switch to receiving the selected broadcast media stream program items according to the selections. For example, the user may indicate that whenever music of a given artist is played on a media stream, the media device starts receiving said media stream.

### LIST OF DRAWINGS

In the following, the invention will be described in greater detail with reference to the embodiments and the accompanying drawings, in which

FIG. 1 illustrates an example of a system in which embodiments of the invention may be utilized;

FIG. 2 illustrates an example of a media device; and

FIGS. 3 and 4 illustrate embodiments of the invention as a flow chart.

### DESCRIPTION OF EMBODIMENTS

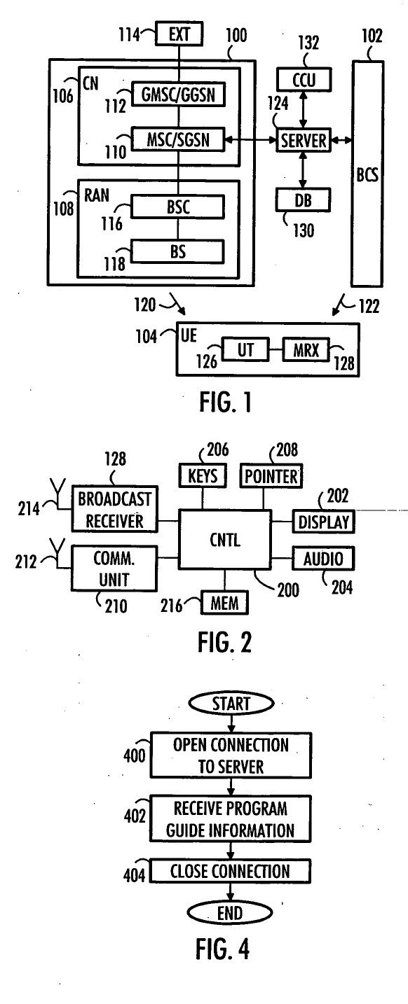

FIG. 1 illustrates an example of a simplified structure of a system in which embodiments of the invention may be utilized. The system comprises a communication network 100 of a cellular telecommunications system, a broadcast system 102, and a media device 104 of the cellular telecommunications system.

The cellular telecommunications system is based on, for example, a GSM (Global System for Mobile Communications) or UMTS (Universal Mobile Telecommunications System). The radio interface used in the communication between the communication network and the media device may be realized using WCDMA (Wideband Code Division Multiple Access) technology, GPRS (General Packet Radio Service) or WLAN (Wireless Local Area Network), or any other similar solution offering services. The structure and functions of cellular telecommunications systems are known to a person skilled in the art, and not all network elements of the system are illustrated.

The communication network 100 provides the media device 104 with bidirectional communication services. The broadcast system 102 provides the media device 104 with a media stream 122 using, for example, a radio or television broadcast.

The communication network 100 may represent the fixed infrastructure of the cellular telecommunication system. The communication network 100 may comprise a core network (CN) 106 representing a radio-independent layer of the communication network 100, and at least one radio access network (RAN) 108. The core network 106 may include network elements of different generations of cellular telecommunications systems. The radio access network 108 provides the media device 104 with a radio interface using radio access technology. The media device thus has a bidirectional radio connection 120 with the radio access network 108.

In the example shown in FIG. 1, the core network 106 is exemplified in terms of GSM terminology using both circuit-switched and packet-switched network elements. The packet-switched network elements are described in terms of a GPRS (General Packet Radio Service) system, which provides the media device 104 with access to external data networks over GSM and supports standard protocols, such as TCP (Transmission Control Protocol) and IP (Internet Protocol). The invention is not, however, restricted to the systems, division of systems, or protocols used in the system described in the examples, but can be applied to any cellular telecommunications system.

A center 110 represents a mobile services switching center (MSC) and a serving GPRS support node (SGSN) enabling circuit-switched and packet-switched signaling, respectively, in the cellular telecommunications system.

A function of the serving GPRS support node is to transmit packets to and receive them from the media device 104 supporting packet-switched transmission. The serving GPRS support node includes subscriber information and location information about the media device 104.

The core network 106 may also have a gateway unit 112 representing both a gateway mobile service switching center (GMSC) and a gateway GPRS support node (GGSN). The GMSC attends to the circuit-switched connections between the core network 106 and external networks (EXT) 114 such as a public land mobile network (PLMN) or a public switched telephone network (PSTN), and the GGSN attends to the packet-switched connections between the core network 106 and external networks 114 such as the Internet.

The center 110 controls the radio access network 108, which may comprise at least one base station controller (BSC) 116 controlling at least one base station (BS) 118. The base station controller 116 may also be called a radio network controller, and the base station 118 may be called a node B.

The system of FIG. 1 further comprises a server 124 connected to the communication network 100 and the broadcast system 102 for providing the media device 104 with a service associated with the media stream 122 by using the radio interface of the cellular telecommunication system. The server 124 may be a computer, such as a personal computer or a workstation with an interface to the communication network 100 and the broadcast system 102. The physical location of the server 124 is not relevant as far as required connections exist. The server 124 may comprise a database 130. The database 130 may comprise computer files containing the service content.

The server 124 may be connected to the center 110, the gateway unit 112, the radio access network 106, or other parts of the communication network 100. The server 124 may be connected to the communication network 100 via an external network 114. In an embodiment, the server 124 communicates with the communication network 100 over the radio interface of the cellular telecommunication system.

The media device 104 comprises a user terminal 126 for communicating in the cellular telecommunication system using a radio interface provided by the base station 118. The media device 104 further comprises a media receiver 128, such as an FM receiver or a television receiver, for receiving a media stream 122 provided by the broadcast system 102.

The base station 118 may communicate with the media device 104 using GPRS, in which data is transferred in packets that contain address and control data in addition to the actual content data. Several connections may employ the same transmission channel simultaneously. This kind of packet switching method is suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and the use of the communication network 100.

The server 124, for example, controls the content flow between the media device 104 and the communication network 100. The server 124 may also facilitate timed delivery of content of the service to the media device 104.

The media stream 122 is broadcasted by the broadcast system 102. The media stream 122 may include, for example, a radio or television program, a commercial or an announcement. The media stream 122 may include speech, music, or pictures. The content of the media stream 122, however, is not relevant to the present solution. The media device is configured to receive the broadcasted media stream 122 with the media receiver 128.

The media device may be provided with a service which is associated and/or synchronized with the broadcasted media stream 122 transmitted by the broadcast system. In general, the service may provide the user of the media device with visual information relative to the content of the broadcast media stream 122. The service may be interactive. The service may include information about the music played at the moment, DJ's messages to the listeners or the like. The signal may include any of these features alone or as a combination thereof. The service may include information about deliver-able or purchasable objects related to the media stream, such as ring tones, desktop wallpapers or logos.

The service may be provided to the media device 104 utilizing a communication channel parallel to the broadcast channel used in delivering the media stream 122 to the user. This is called a-parallel channel operation. A logical address may be dedicated to the service 120 so that the service 120 may be accessed by using the logical address of a database 130 of the server 124. The content of the service may vary as a function of time and possibly as a function of the content of the media stream 122. The service 120 provides a bit stream to the user equipment 104, the bit stream including information content, such as graphical information, text information, audio information, a computer program, Braille, vibration, or any combination thereof. In an embodiment, the content of the service 120 is displayed on a display of the user equipment 104.

A service provider is a party possessing rights for relevant digital content of the service 120, a distribution system for providing the media device. 104 with the service 120, and possibly capability to bill the user for the service 120. The service provider's delivery system is responsible for receiving and handling delivery requests and delivering the service 120 to the media device 104.

In the media device 104, the service provides an integrated user experience, allowing the user to start both listening to a media stream 122 and receiving the content of the service relating to the media stream 122. The operation of the media is based on two channels, the broadcast channel and the parallel channel enabled by the cellular telecommunication system.

In an embodiment, the service concept may be called a visual radio. The broadcast system broadcasts a radio transmission 122 received by the media device 104. The DJ or announcer of the radio transmission may advertise the service realized with the parallel channel. The user of the media device may subscribe to the service by making contact with the server and downloading suitable data which enables the user's media device to receive the service. The data may be called associating data and it may comprise information which provides a linkage between the service and the media stream and which identifies the service transmission.

The associating data may include the following type of information: a radio service address, a service identification, an object identification, a radio broadcaster identification number, a program identification number, a traffic announcement identification number, a traffic program identification number, a program item number, an emergency warning message, a music/speech indicator, a radio frequency utilized by a media stream, a program service name, a program type identification number, and a country code.

In an embodiment, the associating data for service of each broadcast stream is stored in the same programmable program memory location as the information related to the broadcast media stream. Thus, when the user switches to another channel by selecting a programmable memory location the device is able to start receiving the associated service at the same time.

In an embodiment, the system comprises a content creation unit (CCU) 132 connected to the server 124 and the broadcast system 12 for providing content for the service. The content creation unit 132, which can also be called a visual radio tool in some applications, may be used to create service content presentation to be displayed on the media device 104. The content creation unit 132 may be located and integrated into the broadcast system 102, or into the server 124.

The content creation unit 132 may allow a broadcast system to create a visual presentation and manage the content flow shown on the screen of the media device 104 in synchronization with the media stream 122.

The content creation unit 132 may also define timing to display the content of the service in the media device 104 in relation to broadcast media stream timeline.

FIG. 1 shows a broadcast system 102 and a server 124. In practice, there may be several broadcast systems in the same area and each broadcast system may have a server of its own. The servers are connected to the communication network 100 in a similar manner as the server 124. In an embodiment, the server 124 may be connected to several broadcast systems. In another embodiment, the broadcast system 102 may transmit several broadcast media streams.

With reference to FIG. 2, examine an example of a media device in which embodiments of-the invention can be applied. The media device comprises a controller 200, typically implemented with a microprocessor, a signal processor or separate components and associated software. The device further comprises a display 202. The display is typically configured to display graphics and text. The device may also comprise an audio interface 204, which may be realized with a speaker or a headset and a microphone, for example. The device may further comprise a keypad 206 and a pointer device 208, such as a mouse, a track stick or a touch-pad. Depending on the type of the device, there may be different and a different number of user interface parts.

The media device also comprises a communication unit 210 implementing the functions of terminal equipment including speech and channel coders, modulators and RF parts. The device may also comprise an antenna 212 connected to the communication unit. The device may also comprise a broadcast receiver 128 configured to receive broadcast transmissions sent by a broadcast system. The receiver 128 is a radio or television receiver, for example. The device may also comprise an antenna 214 connected to the broadcast receiver 128. The device may also comprise a single antenna connected to both the communication unit 210 and the broadcast receiver 128. The device also typically comprises a memory 216 for storing e.g. telephone numbers, communication parameters, broadcast receiver parameters, calendar data and other user-specific data. The memory may be realized with memory circuits or units or with detachable memory cards.

The media device is not restricted to the above example. The media device may be a personal computer, a personal digital assistant, terminal equipment or any other device comprising required communication facilities.

In an embodiment of the invention, the broadcast system 102 provides the server 124 with program guide information on the broadcast media stream. The server may store the program guide information in the data-base 130.

The program guide information may comprise data about the upcoming programs and the contents of the programs. The data may comprise information about the starting and ending times of programs, names of the programs, hosts or DJs of the programs, a description of each program, information about music tracks played in the programs, artists playing the tracks, and names of albums the tracks are included in.

The program guide information may be provided as a separate service in addition to the service associated and synchronized with the broadcasted media stream providing the user with visual and interactive experience. The program guide information service may be separately acquired from the server 124.

In an embodiment, the program guide information is sent to a media device after the media device has requested such information. The media device may comprise an application configured to request program guide information on different broadcast media streams, receive said information, combine the information to a user-friendly format and display the information to the user of the media device. The program guide information may be stored in the memory 216 of the media device.

In an embodiment, the program guide information is requested at given intervals, so that up-to-date information is always available in the media device. In an embodiment, a program guide information request is performed after receiving a respective command from the user of the media device.

The request sent by the media device to the server 124 may comprise a request to send the program guide information once to the media device. In an embodiment, the request may comprise a request to send program guide information every time the information is changed. Thus, after this kind of request the media device receives the program guide information without explicit requests.

The request sent by the media device to the server 124 may comprise information about the nature of the requested data. For example, the media device may request program guide information regarding a given time interval. The time interval may be a day, a week, the next hour, or any suitable time interval. The server receiving the request responds by sending program guide information only regarding the requested time interval.

In an embodiment, the request sent by the media device to the server 124 may comprise a request to send the program guide information only if the information has changed. The request may indicate the version of the program guide information the media device currently has. The server may also store information indicating when program guide information has been transmitted to media devices, and compare the current program guide information version to the transmitted one and send the program guide information only if the current version has changed since the last transmission.

In an embodiment, the request sent by the media device to the server 124 may indicate the format or amount of details of program guide information to be sent to the media device. For example, the media device may request that the program guide information comprise only headings or names of programs, or that the program guide information comprises more detailed information on each program, such as music tracks to be played in each program.

In an embodiment, the program guide information may also comprise clips or snapshots of associated service content of future programs. The clips or snapshots may comprise information about the content transmitted on the associated service of the broadcast media stream. The information may be a visual clip from the transmission of the service. As the user browses through the program guide displayed on the display of the media device he/she may select a clip or a snapshot linked to a program entry in the program guide to evaluate whether the program is worth listening. Thus, the program guide information may provide an enhanced possibility to select which programs to receive.

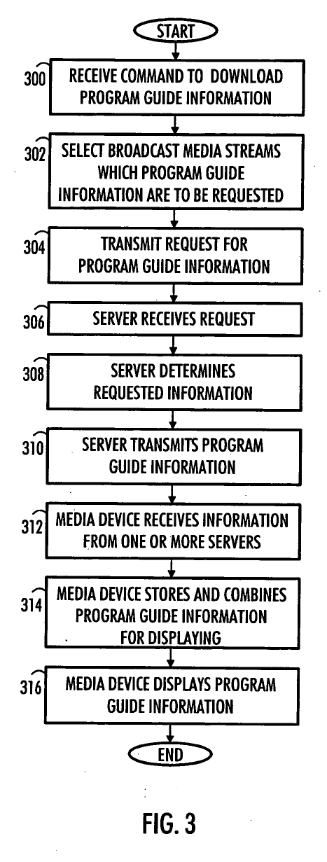

FIG. 3 is a flow chart of an embodiment. In this embodiment, the media device requests the program guide information.

In step 300, a media device 104 receives a command given by the user of the device to download program guide information on broadcast media streams. The media device may also be configured to request program guide information automatically at given intervals without explicit command from the user.

In step 302, there is performed the selection of the broadcast media streams on which program guide information is requested. There may be one or more streams on which program guide information is requested. As stated earlier, the user may have stored information of given media streams in programmable memory locations so that the reception of these streams may be initiated easily. In an embodiment, the program guide information on these media streams is requested. In an embodiment, there is requested program guide information on all media streams for which associating data is known. In an embodiment, the user is presented a possibility to manually select the media streams on which program guide information is requested.

In step 304, the media device 104 transmits a request for program guide information. The request is sent to servers responsible for delivering services of the broadcast media streams selected in step 302. The request may comprise parameters regarding the program guide information to be requested. The parameters may relate to time intervals and the format or amount of details of the program guide information, as already described above.

In step 306, at least one server 124 receives the request for program guide information.

In step 308, the server 124 determines and gathers the requested information from the database 130, for example.

In step 310, the server 124 transmits the requested program guide information to the media device 104 which requested the information.

In step 312, the media device 104 receives the program guide information from one or more servers. The program guide information may be stored in the memory 216 of the media device for future use.

In step 314, the media device 104 processes and combines the program guide information on one or more broadcast media streams into a format suitable for displaying.

In step 316, the media device 104 displays the program guide information on the desired broadcast media streams. Step 318 is not necessarily performed immediately after step 316. In an embodiment, the displaying of the program guide information may be performed after the user has issued a display command. In an embodiment, the program guide information is displayed automatically after the reception of the information.

The media device 104 may send requests for program guide information to several servers in a sequential manner. In an embodiment, the media device 104 opens a TCP/IP connection to a server and sends a request for program guide information. The server responds by transmitting the required information to the media device. The connection between the media device and the server is closed. Next, the media device opens a TCP/IP-connection to a different server and the process continues until program guide information on all selected broadcast media streams is received.

FIG. 4 illustrates another embodiment with a flow chart. In this embodiment, the media device does not request the program guide information. In step 400, the media device opens a TPC/IP connection to a server known to transmit program guide information using the given connection parameters. In step 402, the media device receives the program guide information transmission from the server. In step 404, the connection is closed. The above procedure may be performed automatically without any action from the user, or the user may activate the procedure manually.

In an embodiment of the invention, media device comprises an application configured to search program guide information for program items according to given search parameters and display the search results to the user. The user may give program item selection commands and the application may be configured to perform given actions on the basis of the selections.

In an embodiment, the application switches the media device to receive selected broadcast media stream program items according to the selections. For example, the user may indicate that whenever music of a given artist is played on a media stream, the media device switches to receive said media stream. Thus, every time music of the given artist is played in a broadcast stream whose program guide information has been downloaded, the user may listen to the music automatically. Naturally, also the opposite action may be selected, i.e. the user may wish to avoid listening to music of given artists. In such a case the media device switches to another media stream if music of the selected artist is played on the stream currently being received. The search parameters may comprise program names, program styles, artist names, or other any data the program guide information may comprise.

In an embodiment, application is configured to display an alarm at a predetermined time before the selected content is transmitted in a broadcast stream.

In an embodiment, the application is configured to start receiving and recording selected broadcast media stream program items according to the selections. For example, the user may select one or more programs transmitted on different media streams at different times. The media device switches to receive the streams at the given time and records the programs into a memory of the media device. The recording may be performed silently in the background without actually playing the programs using the speaker of the media device.

In an embodiment, the service associated with a broadcast stream may comprise program delivery control system (PDC) similar to the PDC system used in television systems. The PDC system of television systems is described in more detail in standard ETS 300 231, which is herein incorporated by reference. The service transmission associated with a broadcast stream may comprise PDC signal which includes up-to-date information about starting and ending times of programs or program items. The media device may decode the PDC signal from the service transmission. If the program flow of the broadcast media stream is delayed in the event of an extra news flash, for example, the media device may utilize the PDC signal to correct the recording times set by the user on the basis of the program guide information. Thus, the preprogrammed recordings of programs or program items succeed even if the transmission is unexpectedly delayed.

Next, some embodiments of how program guide information may be obtained are presented. These are various ways to realize the program guide information storage in the cellular network and various ways to deliver the information to users of the service. The number of content providers may vary from one to several servers. The server structure may vary from flat to tree-based structure. The program guide information may be broadcasted or it may be subscribed from the server. Also the detail level of program guide information available from one or more servers may vary. In the following the user is assumed to be able to receive at least one broadcast media stream and associated service, which may be called a visual radio service.

In an embodiment, one server contains program guide information in several levels of detail and broadcasts the information. When the user starts the visual radio application he/she may indicate content types that are interesting. When the visual radio content viewing is turned on, the application responsible for the visual radio starts receiving the visual radio content broadcasted by the server. The transmission of the server comprises also the program guide information. The transmission may be continuous or such that the complete information is transmitted periodically and updates to complete information are transmitted every once in a while. The application responsible for the visual radio shows the user only the information the user has indicated to be interesting. Thus, the server sends all information to each media device but the media device is configured to show only the content indicated to be interesting by the user.

In an embodiment, one server contains program guide information in several levels of detail and transmits the information on request. When the user starts the visual radio application he/she may indicate whether he/she wishes to see the program guide information. If this is indicated, the visual radio application may be configured to query the server which programs are transmitted on different broadcast streams. The server may respond by sending the requested information. If the user wishes to see details of a particular program, the application responsible for the visual radio,may send a query to the server requesting the information. The query may also comprise other parameters determined by the user. For example, the query may comprise a request to show which music is played in different broadcast streams. The visual radio application gathers the requested information, formats the information suitable for the media device display and shows the information.

In an embodiment, one server contains program guide information in several levels of detail and the information transmission is based on subscriptions. When the user starts the visual radio application he/she may indicate which kind of music/programs he/she is interested in. The user may subscribe to receive such information only. The subscription may take place using different connections, such as a short or multimedia message to a service provider or an Internet based connection. When programs or music of a type matching the subscription is transmitted, the server will send visual radio content relating to the subscription to the media device. The media device may, depending on user preferences, switch automatically to the broadcast stream transmitting the material, or alert the user, or set a timer for listening or recording the program/song/material.

In an embodiment, several servers contain program guide information in several levels of detail and broadcast the information. When the user starts the visual radio application and turns on the content viewing, the visual radio application is informed which servers contain program guide information for each broadcast stream. This information may be provided automatically from the network, or it may be previously stored in the media device. The visual radio application will connect to each server and the servers will automatically push the program guide information to the application. When the user wishes to see program guide information, the displayed information is formed from the content which has already been downloaded.

In an embodiment, several servers contain program guide information in several levels of detail and transmit the information on request. When the user starts the visual radio application and turns on the content viewing, the visual radio application is informed which servers contain program guide information for each broadcast stream. If the user wishes to see the program guide information, the visual radio application will contact each server and query from corresponding servers, which programs are being played/broadcast in each broadcast stream. If the user wishes to see the details of a particular program, the visual radio application queries from the server for the information. For example, if the user wishes to see which music is being played in each stream, the visual radio application will ask from each server for the information and will show the results. Each content server may gather and format the information which will be displayed by the visual radio application. The formatting may be performed also by the visual radio application.

In an embodiment, several servers contain program guide information in several levels of detail and the information transmission is based on subscriptions. The description of the previous embodiment is also applicable to this embodiment, with the exception that the user may subscribe to receive information of desired types. The subscription may take place using different connections, such as a short or multimedia message to a service provider or an Internet based connection. There may be one subscription in general to all content, or there may be multiple subscriptions required, one to each server or broadcast stream.

In an embodiment, the media device requesting program guide information first contacts a server which contains links to other servers having the actual information. The server may contain information which other servers contain material for specific broadcast streams. In an embodiment the server contains general information (program level, for example) and information which servers contain more detailed material. There may be many variations in the accessibility of the material in the servers. For example, the general information may be free for all to use but the more detailed material may require a subscription.

In an embodiment, the invention is realized with a computer program distribution medium readable by a computer and encoding a computer program of instructions for executing a computer process for enhancing the use of a media device. The process comprises: requesting a program guide information by the media device over a radio interface of a cellular telecommunication system, the program guide information relating to at least one broadcast media stream; receiving program guide information of at least two broadcast media streams with the media device over a radio interface of a cellular telecommunication system; storing, combining and formatting the received program guide information for display; and displaying at least part of the received information to the user.

The distribution medium may comprise a computer readable medium, a program storage medium, a record medium, a computer readable memory, a computer readable software distribution package, a computer readable signal, a computer readable telecommunications signal, and a computer readable compressed software package.

Even though the invention is described above with reference to an example according to the accompanying drawings, it is clear that the invention is not restricted thereto but it can be modified in several ways within the scope of the appended claims.

1. A method of enhancing the use of a media device, configured to receive a broadcast media stream transmitted by a broadcast system; the method comprising:
receiving over a radio interface of a cellular telecommunication system program guide information on at least one broadcast media stream;
storing and formatting the received program guide information for display;
displaying at least part of the received information to the user.

2. A method of enhancing the use of a media device, configured to receive a broadcast media stream transmitted by a broadcast system; the method comprising
requesting program guide information on at least one broadcast media stream with the media device over a radio interface of a cellular telecommunication system;
receiving program guide information over a radio interface of a cellular telecommunication system;
storing and formatting the received program guide information for display;
displaying at least part of the received information to the user.

3. The method of claim 2, the request comprising parameters regarding the requested program guide information.

4. The method of claim 3, the request comprising a time interval the requested program guide information is to cover.

5. The method of claim 3, the request defining the amount of details of the requested program guide information.

6. The method of claim 1, the program guide information comprising information about the upcoming programs and the contents of the programs.

7. The method of claim 1, the program guide information comprising information about at least one of the following:
the starting and ending times of programs,
titles of the programs,
hosts of the programs,
a description of each program,
music tracks played in the programs,
style of music tracks,
artists playing the music tracks,
titles of albums the tracks are included in.

8. The method of claim 1, further comprising:
receiving program guide information at regular intervals.

9. The method of claim 6, wherein the information about a coming program in the program guide comprises clips of a service being transmitted over a radio interface of a cellular telecommunication system and associated with a broadcast media stream transmitted by a broadcast system.

10. The method of claim 1, further comprising:
receiving program guide information on predetermined media streams.

11. The method of claim 1, further comprising:
receiving program guide information on all media streams available in the area the media device is located.

12. The method of claim 2, further comprising:
initiating program guide information request after receiving a respective command from the user.

13. The method of claim 7, further comprising:
receiving selection commands from the user, the selections relating to broadcast media stream content in the program guide information.

14. The method of claim 13, further comprising:
switching to receive selected broadcast media stream content according to the selections.

15. The method of claim 13, further comprising:
setting the media device to display an alarm at a predetermined time before the selected content is transmitted.

16. The method of claim 13, further comprising:
searching program guide information for program items according to given search parameters;
displaying the search results to the user;
receiving program item selection commands from the user;
controlling the reception of broadcast media stream program items according to the selections.

17. The method of claim 13, further comprising:
switching to record selected broadcast media stream content according to the selections.

18. A media device comprising:
a receiver for receiving a broadcast media stream transmitted by a broadcast system;
a transceiver for communicating with a cellular telecommunication system and receiving a service transmitted over a radio interface of the cellular telecommunication system, the service being associated with at least one broadcast media stream, and for receiving program guide information relating to at least one broadcast media stream;
a memory for storing the received program guide information;
a processor connected to the transceiver and receiver for formatting the received information; and
a user interface connected to the processor for displaying at least part of the received information to the user.

19. The media device of claim 18, comprising an application for
setting up a program guide information request, the program guide information relating to at least one broadcast media stream;
sending the request using the transceiver,
storing the received program guide information;
formatting the program guide information for display and
displaying the program guide information.

20. The media device of claim 18, comprising an application further configured to set up a request comprising parameters regarding the requested program guide information.

21. The media device of claim 18, comprising an application further configured to set up a request comprising a time interval the requested program guide information is to cover.

22. The media device of claim 18, comprising an application further configured to
search program guide information for program items according to given search parameters;
display the search results to the user;
receive program item selection commands from the user;
control the reception of broadcast media stream program items according to the selections.

23. The media device of claim 22, comprising an application further configured to record broadcast media stream program items according to the selections.

24. A network server having a capability to connect to a telecommunication system and to a broadcast system transmitting a broadcast media stream, configured to
receive program guide information relating to at least one broadcast media stream from the broadcast system, and
send the program guide information over the radio interface of the telecommunication system to media device having requested the information.

25. A network server of claim 24, configured to receive a program guide information request from a media device over a radio interface of a cellular telecommunication system, and
send the program guide information in response to the request.

26. A computer program product encoding a computer program of instructions for executing a computer process for enhancing the use of a media device, the process comprising:
receiving program guide information on at least one broadcast media stream with the media device over a radio interface of a cellular telecommunication system;
storing and formatting the received program guide information for displaying;
displaying at least part of the received information to the user.

27. The computer program product of claim 26, wherein the process further comprises requesting program guide information on at least one broadcast media stream with the media device over a radio interface of a cellular telecommunication system.

28. A computer program distribution medium readable by a computer and encoding a computer program of instructions for executing a computer process for enhancing the use of a media device, the process comprising:
requesting program guide information on at least one broadcast media stream with the media device over a radio interface of a cellular telecommunication system;
receiving program guide information on at least two broadcast media streams with the media device over a radio interface of a cellular telecommunication system;
storing and formatting the received program guide information for displaying;
displaying at least part of the received information to the user.

29. The computer program distribution medium of claim 28, wherein the process further comprises requesting program guide information on at least one broadcast media stream with the media device over a radio interface of a cellular telecommunication system.

30. The computer program distribution medium of claim 28, the distribution medium comprising a computer readable medium, a program storage medium, a record medium, a computer readable memory, a computer readable software distribution package, a computer readable signal, a computer readable telecommunications signal, and a computer readable compressed software package.
